(19) United States
(12) Patent Application Publication
(10) Pub. No.: US 2007/0138450 A1
(43) Pub. Date: Jun. 21, 2007

(54) MOBILE LIFT TABLE WITH RAISABLE CASTERS

(76) Inventor: Norma BRADLEY, Fredericton (CA)

Correspondence Address: MARIO D. THERIAULT, 812 HWY. 101 NASONWORTH, FREDERICTON, NB, E3C 2B5, CA

(21) Appl. No.: 11/567,256

(22) Filed: Dec. 6, 2006

Related U.S. Application Data
(60) Provisional application No. 60/750,355, filed on Dec. 15, 2005.

(51) Int. Cl. B60P 1/48

(52) U.S. Cl. 254/9 C

(57) ABSTRACT

The mobile lift table has a base; a scissor lift mechanism mounted to the base; a tabletop mounted over the upper end of the scissor lift mechanism, and casters assemblies affixed to side vertices on the scissor lift mechanism, at intermediate vertical positions along the scissor lift mechanism, such that these caster assemblies are raised from the floor when the scissor lift mechanism is extended by a small distance, thereby immobilizing the lift table. In another aspect of the present invention, the casters are mounted directly to tabletop of the mobile lift table. Each of the casters has a rolling surface extending below the base when the scissor lift mechanism is in a collapsed position. In this particular aspect of the invention, the casters are lifted off the floor at the same time as the tabletop starts to rise, to immobilize the lift table.

This application claims the benefit of U.S. Provisional Application No. 60/750,355, filed Dec. 15, 2005.

### FIELD OF THE INVENTION

This invention pertains to mobile lift tables, and more particularly, this invention pertains to a scissor-type lift table having a base, a scissor lift mechanism mounted to the base, and casters mounted to the scissor lift mechanism for movement of the casters above and below the base.

### BACKGROUND OF THE INVENTION

In a home-based wine-making process, large containers such as carboys and even small barrels are used for containing water and juices during the mixing, fermenting, infusing, filtering and bottling phases. Some of these phases require the transfer of liquid from one container to another. Some of these phases also require the movement of containers from one environment to another, for varying a temperature or light intensity for example. Therefore, the entire wine-making process comprises several manipulations of containers.

The transferring of a wine-in-progress between two containers is generally done by siphoning the content of a raised container into a lower one. Therefore, these large containers must be moved and raised during the making of a batch of wine.

Typically, the carboys used in a wine-making process contain 5 US gallons, (18.9 litres), and 6 US gallons, (23 litres). These containers are usually made of glass and can weigh 60-75 lbs when full. The lifting and moving of these carboys require considerable physical effort which is not possible for everyone.

Movable lift tables are available in the prior art for handling large liquid containers or similar objects in laboratories and industrial environments. Although these lift tables are not promoted particularly to the home-based winemakers, it is believed that they may be used with limited success to handle wine-making carboys in a home-based process.

Examples of movable lift tables of the prior art are as follows;
U.S. Pat. No. 4,447,041 issued to Hiromu Fujita on May 8, 1984; and
U.S. Pat. No. 4,867,277 issued to William C. Sloan on Sep. 19, 1989.

Each of the movable lift tables mentioned above has a scissor lift mechanism, a base on which the mechanism is mounted, and a tabletop mounted on the upper end of the mechanism. The base is mounted on wheels so that the lift table is movable to transport a container or a similar object from one place to another. The movable lift tables in these examples describe typical apparatus that are available commercially in various shapes and sizes.

Although the movable lift tables of the prior art can be use to alleviate strains in the manipulation of wine-making carboys, their wheels are mounted to their bases, and therefore, these lift tables are movable on a floor, in the raised positions. Consequently, a winemaker using one of these lift tables, or other people in a same household as the winemaker, may try to move a full carboy on a lift table in the raised position. When a caster or a wheel on the lift table rolls against an obstruction on the floor, such as an extension cord, a doorsill or a rug for example, the carboy may tip and an entire batch of wine may be ruined.

It is believed that because of this possibility, home-based winemakers would be hesitant to use any of the movable lift tables of the prior art. It is also believed that there is a need in the home-based winemaking field for an improved movable lift table that can become immovable when the tabletop is in a raised position. It is believed that there is a need in this market for a movable lift table that becomes quickly immovable as soon as the tabletop starts to rise, and which remains immovable as long as the tabletop is in a raised position, even to a slight extent.

### SUMMARY OF THE INVENTION

The mobile lift table with raisable casters according to the present invention has a base; a scissor lift mechanism mounted to the base; a tabletop mounted over the upper end of the scissor lift mechanism, and casters assemblies affixed to a raisable portion thereof such that these caster assemblies are raised from the floor when the scissor lift mechanism is extended, thereby readily immobilizing the lift table.

More specifically, in one aspect of the present invention, the scissor lift mechanism has parallel front and back portions each having an upper arm pair and a lower arm pair. The upper and lower arm pairs on each of the front and back portions are connected to each other and define a parallelogram having side vertices. Each of the front and back portions further has a pair of caster assemblies mounted thereto at the side vertices. When the scissor lift mechanism is extended a slight distance, the caster assemblies are lifted up relative to the base, to immobilize the lift table.

In another aspect of the present invention, the casters are mounted directly to the tabletop of the mobile lift table. Each of the casters has a rolling surface extending below the base when the scissor lift mechanism is in a collapsed position. In this particular aspect of the invention, the casters are lifted off the floor at the same time as the tabletop starts to rise.

In addition to immobilizing the lift table as soon as the tabletop thereof starts to rise, the mounting of the casters to the scissor lift mechanism provides additional advantages that makes this mobile lift table particularly suitable for use in a home-based application. The mounting of the casters to the scissor lift mechanism is particularly advantageous for facilitating the extension of the scissor lift mechanism from a collapsed position, which initial extension can therefore be effected using a hand driven actuator, without much difficulty, even if a relatively heavy load is carried on the tabletop of the lift table. These advantages will be understood from the following explanations and from other descriptions related to the preferred embodiments of the present invention.

In reference to these additional aspects and advantages, the scissor lift mechanism is actuated by a threaded actuator engaged with mirrored arms in the scissor lift mechanism. The rolling surface of each caster extends below the base when the scissor lift mechanism is in a collapsed position, a distance corresponding to a vertical extension of the scissor lift mechanism from the working of the threaded actuator about two turns. An initial turning on the threaded actuator, from a collapsed position of the scissor mechanism, is thereby greatly facilitated by the weight of the base during a downward movement of the base.

In yet another aspect of the present invention, there is provided a method for facilitating the extension of a scissor lift mechanism from a collapsed position, wherein the scissor lift mechanism is mounted to a base and has parallel front and back portions each having an upper arm pair and a lower arm pair, with the upper and lower arm pairs in each of the front and back portions being connected to each other and defining a parallelogram having side vertices; and two pairs of support members mounted to the side vertices. The method comprises the steps of supporting said lift table on a floor surface on the support members with the base thereof raised from the floor surface, and with the lower arm pairs extending at a first angle from the base. The method also comprises the step of causing the lower arm pairs to rotate to a second angle while the base is lowered to the floor surface, wherein a tangent of the second angle is 50% larger than a tangent of the first angle.

In yet a further aspect of the present invention, the method for facilitating the extension of a scissor lift mechanism from a collapsed position, includes the step of applying a torque on the lower arm pairs in a direction of movement of these arms from the first angle to the second angle.

Further explanations concerning the physics related to the initial movement of a scissor lift mechanism from a collapsed position are provided hereinafter while describing the preferred embodiments of the present invention.

This brief summary has been provided so that the nature of the invention may be understood quickly. A more complete understanding of the invention can be obtained by reference to the following detailed description of the preferred embodiments thereof in connection with the attached drawings.

### BRIEF DESCRIPTION OF THE DRAWINGS

Two embodiments of a mobile lift table with raising casters are illustrated in the attached drawings. In these drawings the same numerals are used to identify the same elements. In the drawings;

FIG. 1 is a perspective front and left side view of the mobile lift table according to a first preferred embodiment of the present invention, in an extended position;

FIG. 2 is a front view of the mobile lift table in a collapsed position;

FIG. 3 is a front view of the mobile lift table with the scissor lift mechanism in an intermediate position where the rolling surface of each caster thereof is at a same elevation as the base;

FIG. 4 is a front view of the mobile lift table with the scissor lift mechanism in an extended position;

FIG. 5 shows a second preferred embodiment of the present invention, wherein the casters thereof are affixed to the tabletop of the mobile lift table;

FIG. 6 shows the mobile lift table according to the second preferred embodiment in a collapsed position;

FIG. 7 is a first graph showing a representation of the rate of elevation of the tabletop on the first preferred mobile lift table;

FIG. 8 is a second graph showing a representation of the rate of elevation of the tabletop on the second preferred mobile lift table.

### DETAILED DESCRIPTION OF TWO PREFERRED EMBODIMENTS

While this invention is susceptible of embodiment in many different forms, there are shown in the drawings and will be described in details herein, two specific embodiments of a mobile lift table with raisable casters. It should be understood that the present disclosure is to be considered as an example of the principles of the invention and is not intended to limit the invention to the embodiments illustrated and described.

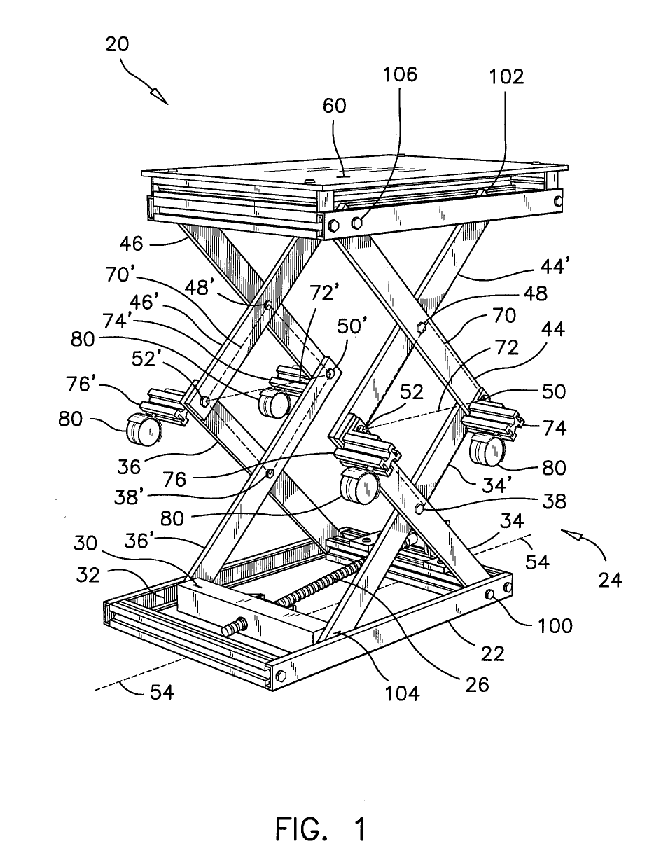

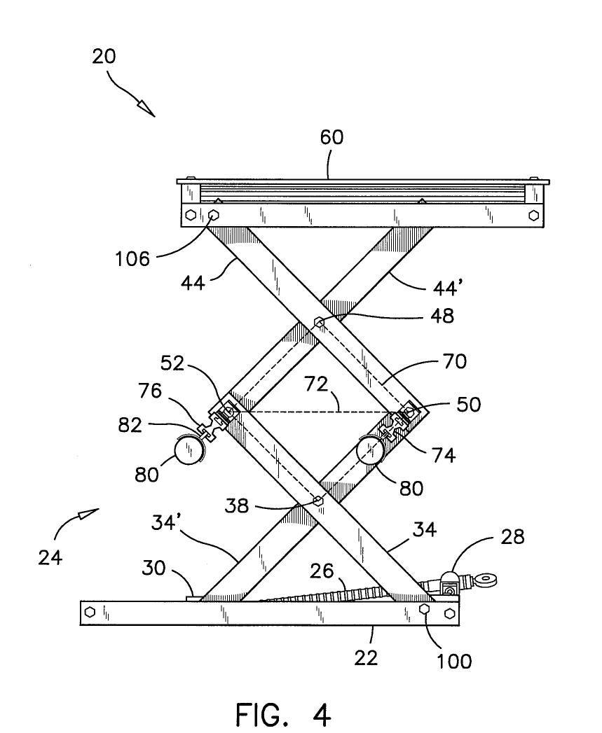

Two embodiments are disclosed herein because the two embodiments have common structural features and advantages. Therefore, it is believed that both embodiments belong to a same inventive concept. Referring firstly to FIGS. 1-4, the mobile lift table 20 according to the first preferred embodiment will be described.

The first preferred mobile lift table with raisable casters 20 has a rectangular base which is identified by the label 22. A scissor lift mechanism 24 and a threaded actuator 26 thereof are mounted to the base 22. The threaded actuator 26 has a drive end extending through a thrust bearing 28 which is affixed to the base 22, and a driven end extending into a slider block 30. The slider block 30 is mounted in slides 32 along the base 22 and is movable along the base 22.

The scissor lift mechanism 24 has one pair of arms 34,36, pivoted to the base 22 and one pair of arms 34′, 36′ pivoted to the slider block 30. The mounting of the scissor lift mechanism 24 to the base 22, as well as the operation of the scissor lift mechanism 24 are not explained any further herein because these details are known to those skilled in the art, and do not constitute the focus of the present invention.

In the scissor lift mechanism 24, the front lower arm pairs 34, 34′ are pivoted to each other by a first central pivot connection 38 passing through their mid regions. Similarly, the rear lower arm pair 36, 36′ are pivoted to each other by a second central pivot connection 38′ passing through their mid regions. Upon the upper ends of the arm pairs 34, 34′ and 36, 36′ there are respectively mounted two upper arm pairs 44, 44′ and 46, 46′. The upper arm pair 44 and 44′, are connected to each other at their mid regions by a third central pivot connection 48, and are respectively connected to the lower arm pairs 34′ and 34, by means of a pair of outside pivot connections 50 and 52 respectively. Similarly, the upper arm pair 46 and 46′ are connected together at their mid regions by a fourth central pivot connection 48′, and are respectively connected to the lower arm pairs 36′ and 36, by means of a pair of outside pivot connections 50′ and 52′ respectively.

The arm pairs 34, 34′ and 36, 36′ are parallel to each other relative to the longitudinal axis 54 of the base 22. Similarly, the upper arm pairs 44, 44′ and 46, 46′ are parallel to each other relative to the longitudinal axis 54. The arms in a same pair are also referred to herein as mirrored arms.

The first preferred mobile lift table with raisable casters 20 has a tabletop 60 mounted to the upper ends of the upper arm pairs 44, 44′ and 46, 46′. The tabletop 60 is mounted to the upper ends of the upper arm pairs in a similar manner as the lower ends of the lower arm pairs are mounted to the base 22. Such mounting is also known to those skilled in the art and therefore does not require more explanation.

Additional arm pairs may be affixed to the upper arm pairs 44, 44′ and 46, 46, between these upper arm pairs and the tabletop 60, as may be required for a special application, for example.

Arms 34, 44, 36 and 46 are parallel to each other and are mounted to the outside of the scissor lift mechanism 24, relative to the longitudinal axis 54 of the base 22.

The pivot connections 38, 52, 48, and 50 define a front parallelogram 70. The pivot connections 38′, 52′, 48′, and 50′ define a rear parallelogram 70′. Both parallelograms 70,70′ are parallel relative to each other and to the longitudinal axis 54 of the base 22.

Pivot connections 50 and 52 define a horizontal diameter 72 of the parallelogram 70, and pivot connections 50′ and 52′ define a horizontal diameter 72′ of the parallelogram 70′. Pivot connections 50, 52, and 50′, 52′ are also referred to as the side vertices of the parallelograms 70 and 70′ respectively.

A pair of front caster support members 74 and 76 are affixed to the lower end of the outside upper arm 44 and to the upper end of outside lower arm 34 respectively at pivot connections 50 and 52 respectively. A rear pair of caster support members 74′ and 76′ are mounted to lower end of outside upper arm 46 and to the upper end of outside lower arm 36 respectively at pivot 50′ and 52′ respectively.

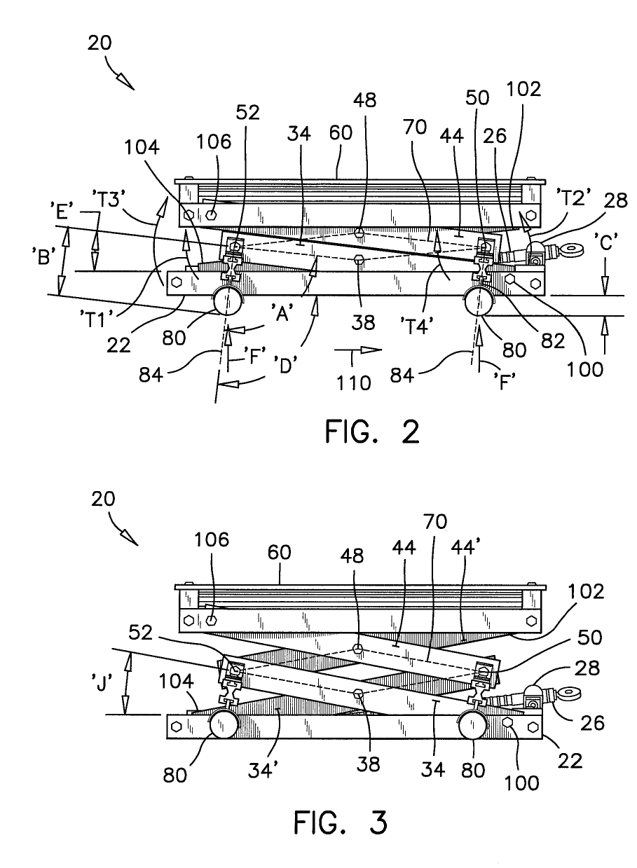

A caster 80 is mounted to each of the caster support members 74, 76, 74′, 76′. Each caster 80 has a stem 82 thereon and is mounted below the pivot connection to which its respective support member is affixed. Each caster 80 is thereby vertically offset from the respective arm 34, 44, 36, 46 to which it is mounted. Referring particularly to FIG. 2, each caster support member is mounted in such a way that an upright axis 84 of each caster assembly, including a caster, a caster stem and a caster support member, makes a right angle “A” with the respective arm 34, for example, to which it is mounted.

When the scissor lift mechanism 24 is fully retracted, the rolling surface of each caster is at a distance “B” from a respective pivot connection, 50, 52 for example, such that the base 22 is raised off the floor a preferred distance “C”, of about 1 inch (25 mm) for example. The base elevating distance “C” is preferably equivalent to the elevation of the scissor lift mechanism 24 caused by the working of the threaded actuator 26 about two turns.

Several advantages derive from the caster arrangement just described and from the preferred base elevating distance “C”. These advantages are explained herein below. Firstly, the mounting of the casters 80 to the outside arms 34, 44, 36, 46 of the scissor lift mechanism 24, at the side vertices of the parallelograms 70, 70′ causes the base 22 to be lowered quickly to the floor upon turning the threaded actuator 26 an initial displacement of two turns. The mobile lift table 20 is thereby stable on its base 22 as soon as an extension of the scissor lift mechanism 24 is initiated.

Secondly, a common scissor lift mechanism with a manually-operated threaded actuator is more difficult to turn when the mechanism is in a collapsed position, and is easier to operate when the mechanism is in an extended position. When a heavy load is carried on the top of a common scissor lift mechanism, and the mechanism is in a lowest position, the threaded actuator is generally relatively hard to turn. If this mechanism has not been used for some time and a good lubrication has been neglected, one could have difficulty in extending the mechanism from its lowest position. As a result, excessive force on the threaded actuator may cause the lift table to lean or to tip over. For this reason, movable lift tables of the prior art are commonly equipped with hydraulic or electric actuators, which of course increase their selling price to users.

In the preferred mobile lift table 20, the initial movement of the base 22 downward, reduces the initial rate of elevation of the tabletop 60 by one half as compared to the rate of elevation of a conventional scissor lift mechanism having casters affixed to its base. The force on the threaded actuator is thereby also reduced by the same amount.

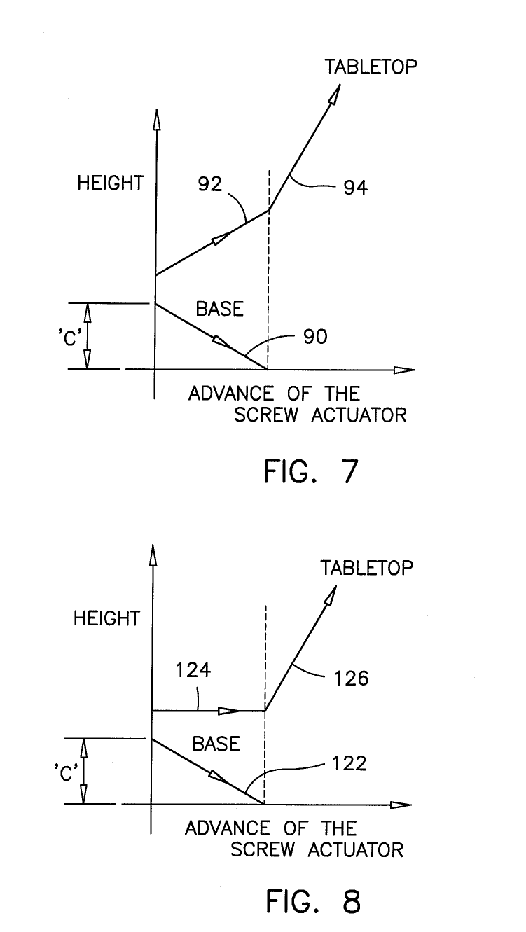

This rate of elevation is better understood while making reference to FIG. 7. Upon turning the threaded actuator 26, the base moves downward as illustrated by line 90 in FIG. 7, for being driven downward relative to the casters by the two lower arm pairs 34, 34′, 36, 36′. At the same time, the tabletop 60 moves upward by the same distance as shown by line 92 for being driven upward relative to the casters by the two upper arm pairs 44, 44′, 46, 46′. As soon as the base 22 touches the floor, however, the rate of elevation 94 of the tabletop 60 increases by a factor of two for being driven upward relative to the base 22 by all four arm pairs.

It will be understood that during the initial descent of the base 22, the force required on the threaded actuator 26 is only half of what it would be if the casters would be affixed to the base. The lower resistance in the scissor lift mechanism 24 during the initial displacement of the base 22, facilitates the initial elevation of the scissor lift mechanism from a collapsed position, as compared to a scissor lift mechanism of the prior art.

Moreover, it will be appreciated that the force required on the threaded actuator 26 for moving the tabletop from a lowest position, is inversely proportional to the tangent of the angle that the arm 34 for example, makes with the base 22. In the preferred mobile lift table 20, the angle ‘E’ of the arm 34 relative to the base 22 when the scissor mechanism is in a collapsed position is about 7°. The position of the arm 34 when the base 22 is about to touch the floor, as illustrated in FIG. 3 is at an angle ‘J’ of 11°. The tangent of 7° is 0.123. The tangent of 11° is 0.194. Based on these values, it will be appreciated that the force required to extend the scissor lift mechanism 24 from its collapsed position, is reduced by almost 60% after the base 22 has been lowered to the floor. Therefore, the mounting of the casters to the arms of the scissor lift mechanism 24 greatly reduces the difficulties associated with the extension of the scissor lift mechanism from a collapsed position.

Thirdly, a vertical force “F” on the caster 80 mounted to the arm 34 for example, generates a torque “T1” on arm 34 about pivot connection 100 on the base 22. This torque “T1” also generates an upright force on arm end 102 under the tabletop. A vertical force “F” on the caster 80 affixed to arm 44 generates a moment “T2” on arm 34′ about arm end 104 on the base 22. The torque “T2” generates an upright force on arm end 106 under the tabletop. Both moments “T1” and “T2” urge the scissor lift mechanism 24 to extend, thereby facilitating the movement of the threaded actuator 26 when initiating a lift of the scissor lift mechanism 24 from a collapsed position.

Fourthly, the mounting of the casters 80 with their upright axes 84 making a right angle “A” with the arms to which they are mounted, also has a consequence of placing each upright axis 84 at an obtuse angle “D” from the base 22. Because each upright axis 84 makes an obtuse angle “D” with the base 22, the vertical forces “F” on a caster, from the weight of the lift table 20, causes a moment “T3” on arm 34 about the pivot connection 52 and a moment “T4” on arm 44 about the pivot connection 50. Both moments “T3” and “T4” causes the arms 34 and 44 to rotate in the direction of extension of the scissor lift mechanism 24, thereby further facilitating the extension of the lift table from a collapsed position of the scissor lift mechanism 24.

Because of all these advantages, it becomes feasible to manufacture and sell mobile lift tables with a manually-operated cranks, to home-based winemakers, for handling heavy carboys without difficulty.

Finally, another advantage of the inclination “D” of the casters is related to the movement of the first preferred mobile lift table 20 on a floor surface in a direction toward the operable end of the threaded actuator 26, as illustrated by arrow 110 in FIG. 2. Normally, a handle (not shown) for operating the threaded actuator 26 is also used as a hook (not shown) to engage with the drive end of the threaded actuator 26 and to move the mobile lift table 20 from one place to another. Therefore the direction of arrow 110 is a forward direction of the mobile lift table 20. The inclination “D” of the casters' upright axes 84 causes the caster stems 82 and the caster support members 74, 76, 74′, 76′ to flex more easily away from a forward direction 110, to better absorb shocks without raising the tabletop 60, whenever one of the casters encounters an obstruction on the floor for example, while moving in the forward direction 110.

Before all, however, the first preferred mobile lift table with raisable casters 20 is safer to use than the elevating carts of the prior art, because it quickly becomes immovable when the scissor lift mechanism is raised by only a slight distance “C” from the floor.

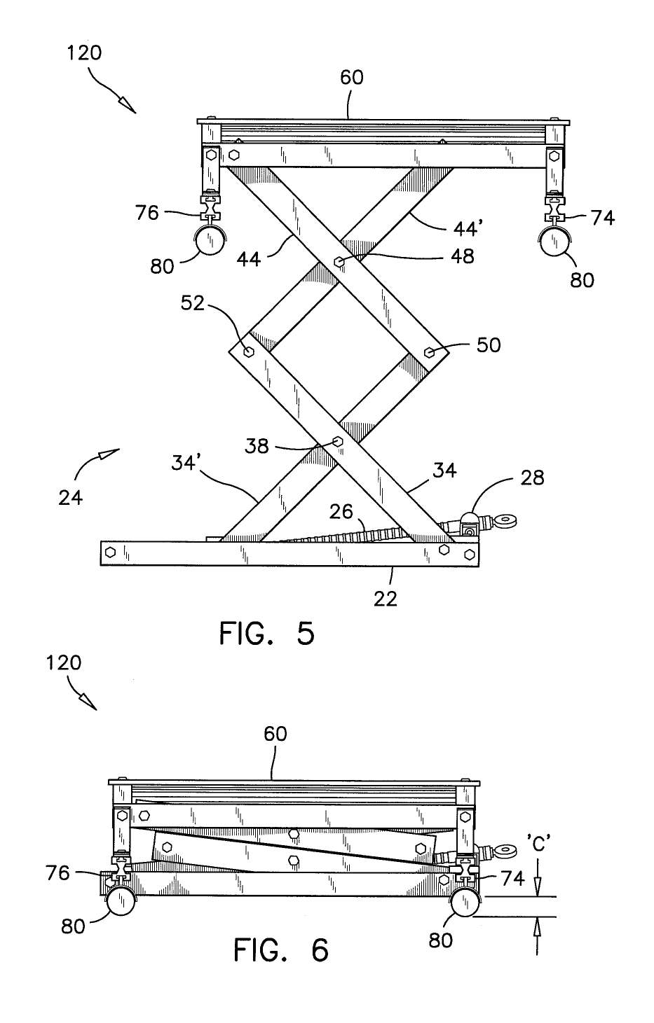

Referring now to FIGS. 5, 6 and 8, the second preferred mobile lift table with raisable casters 120 will be described. The structure of the second preferred mobile lift table 120 is basically the same as the structure of the first preferred embodiment 20, with the exception that the casters 80 and caster support members 74, 74′, 76, 76′ are affixed to the tabletop 60. The advantage of this embodiment is that the lift table 120 becomes immovable as soon as the casters are raised from the floor.

The casters 80 in this second preferred embodiment are mounted in such a way as to raise the base 22 a distance “C” of about 1 inch (25 mm), when the scissor lift mechanism 24 is in a collapsed position, as shown in FIG. 6. The purpose of this clearance ‘C’ is to facilitate the operation of the scissor lift mechanism 24 during an initial extension of the mechanism as previously explained. Again, this clearance ‘C’ is equivalent to the extension of the scissor lift mechanism 24 from about two turns of the threaded actuator 26.

In FIGS. 5, 6 and 8, one can appreciate that an advance of the threaded actuator 26, from a collapsed position of the scissor lift mechanism 24, causes the base to move down as illustrated by line 122 in FIG. 8. During this initial step, the tabletop 60 remains at a same level, as represented by line segment 124, for being supported by the casters. When the base 22 rests firmly on the floor, then the tabletop 60 starts rising as illustrated by the line segment 126. This initial movement “C” mentioned herein is for example only. The objective of this initial displacement is to move the pivot connections 38 and 48 a sufficient distance apart so that the threaded actuator 26 can be easily rotated by hand without excessive effort, and without causing the mobile lift table to become unstable in any way.

While two preferred embodiments of the mobile lift table have been described herein and illustrated in the accompanying drawings, it will be appreciated by those skilled in the art that various modifications, alternate constructions and equivalents may be employed without departing from the spirit and scope of the invention.

For example, the scissor lift mechanism illustrated has four arm pairs connected to each other. It will be understood that this mechanism could have more than four arm pairs and the casters could be mounted to a level above the one illustrated, to obtain a different model of mobile lift table that can be used in a special application.

Also, the upright axes of the caster assemblies can be mounted to define a right angle or an acute angle with the arm to which they are mounted, and still obtain some of the advantages described herein.

It should also be appreciated that a method for facilitating the extension of a scissor lift mechanism from a collapsed position could be carried out with static support members instead of casters, in a stationary lift table for example.

The threaded actuator 26 can also be mounted to cross members between side vertices 50, 50′ and between side vertices 52, 52′, or to the arm ends under the tabletop 60, to obtain substantially the same results as described herein.

The utility of the mobile lift table according to the present invention, in a home-based wine-making market, as mentioned herein, should not be taken as a limitation in any of the apparatus and method claims recited hereinafter. The use of the mobile lift table, as mentioned herein, is for example only. Other markets can also enjoy the advantages of this invention.

The apparatus and method claimed hereinafter intend to cover manufactures, sales and uses of new mobile lift tables, as well as the retrofit of existing lift tables with casters or wheels according to the instructions provided herein.

Therefore, the above description and the illustrations should not be construed as limiting the scope of the invention, which is defined by the appended claims.

What is claimed is:

1. A mobile lift table comprising;
a base; a tabletop and a scissor lift mechanism having a lower end and an upper end and means for extension thereof vertically; said lower end being mounted to said base and said tabletop being mounted to said upper end; said scissor lift mechanism having parallel front and back portions each having an upper arm pair and a lower arm pair, said upper and lower arm pairs in each of said front and back portions being connected to each other and defining a parallelogram between said upper and lower ends above said base; said parallelogram having side vertices; and each of said front and back portions further comprising a pair of casters assemblies mounted thereto at said side vertices.

2. The mobile lift table as claimed in claim 1, wherein said base has a longitudinal axis and each of said upper and lower arm pairs has an inside arm and an outside arm relative to said longitudinal axis, and said casters assemblies being mounted to said outside arms.

3. The mobile lift table as claimed in claim 2, wherein each of said caster assemblies comprising a support member and a caster having a stem affixed to said support member, said caster being vertically offset from a respective one of said outside arms, and said caster, said stem and said support member defining an upright axis extending at a right angle from said respective outside arm.

4. The mobile lift table as claimed in claim 3, wherein each of said upright axes makes an obtuse angle with said base.

5. The mobile lift table as claimed in claim 4, wherein said means for extension thereof vertically is a threaded actuator extending along said longitudinal axis and having a drive end and a driven end, and said obtuse angle faces said drive end.

6. The mobile lift table as claimed in claim 3, wherein each of said casters has a rolling surface extending below said base a distance corresponding to an extension of said scissor lift mechanism caused by a rotation of said threaded actuator about two turns, when said scissor lift mechanism is in a collapsed position.

7. A method for facilitating the extension of a scissor lift mechanism from a collapsed position, wherein said scissor lift mechanism is supported to a base and has; parallel front and back portions each having an upper arm pair and a lower arm pair, said upper and lower arm pairs being connected to each other and defining a parallelogram having side vertices; and two pairs of support members mounted to said side vertices; said method comprising the steps of;
supporting said lift table on a floor surface on said support members, with said base being raised from said floor surface and said lower arm pairs being at a first angle from said base;
causing said lower arm pairs to rotate to a second angle, greater than said first angle, while lowering said base to said floor surface, wherein a tangent of said second angle is 50% larger than a tangent of said first angle.

8. The method as claimed in claim 7, wherein said scissor lift mechanism also comprises a threaded actuator connected to said lower arm pairs, and said step of causing said lower arm pairs to rotate to a second angle corresponds to turning said threaded actuator about two turns.

9. The method as claimed in claim 8, wherein said step of causing said lower arm pair to rotate to a second angle further comprises the steps of applying a torque on said support members and said arms in a direction of movement of said arms from said first angle to said second angle.

10. A mobile lift table comprising;
a base; a tabletop and a scissor lift mechanism having a lower end and an upper end and means for extension thereof vertically; said lower end being mounted to said base and said tabletop being mounted to said upper end; and a plurality of casters mounted to said tabletop, wherein each of said casters having a rolling surface extending below said base when said scissor lift mechanism is in a collapsed position.
